(19) United States
(12) Patent Application Publication
(10) Pub. No.: US 2009/0248292 A1
(43) Pub. Date: Oct. 1, 2009

(54) ROUTE GUIDANCE DEVICE, ROUTE GUIDANCE METHOD, AND ROUTE GUIDANCE PROCESSING PROGRAM

(75) Inventors: Hajime Adachi, Saitama (JP); Takahiko Terada, Saitama (JP); Tsuyoshi Sakamoto, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/295,455

(22) PCT Filed: Mar. 14, 2007
(86) PCT No.: PCT/JP2007/055142

§ 371 Date: Apr. 13, 2009

(30) Foreign Application Priority Data
Mar. 30, 2006 (JP) 2006-093122

(51) Int. Cl. G01C 21/00

(52) U.S. Cl. 701/201

(57) ABSTRACT

To reliably avoid a dangerous zone by setting a route from a current position to a temporary destination so as to avoid the dangerous zone while reflecting prediction results of a moving direction even when a route setting is not previously made. A route to a temporary destination is set based on location information obtained and prediction results of a moving direction of a user, so that even when an avoidance scheduled route for avoiding a dangerous zone has not been decided in advance, the route from the current position to the temporary destination can be reliably set so as to avoid the dangerous zone, while reflecting the prediction results of the moving direction. As a result, safe and reliable route guidance while avoiding the dangerous zone can be executed.

### CROSS-REFERENCE TO RELATED APPLICATION

This application is based on Japanese Patent Application No. 2006-093122 filed on Mar. 30, 2006, the contents of which is incorporated hereinto by reference.

### BACKGROUND OF THE INVENTION

1. Field of the Invention

The present invention relates to a route guidance device, a route guidance method, and a route guidance processing program for providing a route to a destination.

2. Description of the Related Art

Generally, a route guidance device for guiding a route to a destination has a map information obtaining means for reading and obtaining map information, an information inputting means for inputting a destination, various guiding conditions, and the like which are set by an operator using a suitable operating means, a location information obtaining means for obtaining location information of the operator or the route guidance device utilizing, for example, a GPS (Global Positioning System), a route setting means for setting a route from a current position to a destination based on the aforementioned map information and guiding conditions, and the like.

Conventionally, as such a route guidance device, there is disclosed a car navigation apparatus as described in, for example, JP, A, 2004-94444 (FIG. 34 to 37) for guiding a driving route of vehicles. In the car navigation apparatus, a route setting means (in-vehicle apparatus) sets a route to avoid an area where traffic accidents occur frequently based on traffic accident information obtained from traffic accident information database. There is also disclosed a route guidance device as described in, for example, JP, A, 2001-336947 for guiding a walking route of pedestrians. In this route guidance device, a route setting means sets a route to avoid a point of interfering with walking, such as narrow sidewalks, steps, escalators, and the like according to user's needs.

In the aforementioned prior art, the operator previously sets a destination, and thereby a route from an origin to the destination is set by the route setting means so as to avoid the aforementioned areas, which should be avoided (accident-prone area, narrow sidewalk, and the like). However, when the operator drives a vehicle or walks without setting the route due to, for example, forgetting to set the destination and the like safe route guidance cannot be executed while avoiding the areas which should be avoided, so that there has been a possibility that the operator could not avoid the areas.

Problems that the present invention aims to solve include the aforementioned problem as one example.

### SUMMARY OF THE INVENTION

In order to solve the aforementioned problems, the invention according to claim 1 is a route guidance device for guiding a route to a moving operator, comprising: an area information obtaining unit that obtains information on a zone to be avoided associated with map data; a location information obtaining unit that obtains location information of the operator or the route guidance device; an avoidance route setting unit that sets a route to a temporary destination while avoiding entering the zone to be avoided obtained by the area information obtaining unit; based on the location information obtained by the location information obtaining unit and prediction results of a moving direction of the operator or the route guidance device, and a display signal generating unit that generates a display control signal for displaying the route to the temporary destination set by the avoidance route setting unit, wherein: the avoidance route setting unit includes: a moving direction predicting unit that predicts the moving direction of the operator or the route guidance device based on the location information obtained by the location information obtaining unit, a temporary destination setting unit that sets a temporary destination along the moving direction predicted by the moving direction predicting unit based on the information on the zone to be avoided obtained by the area information obtaining unit and the map data, and corrects the temporary destination thereafter in the case previously defined, a route determining unit that determines the route from a location concerning the location information to the temporary destination corrected after being set by the temporary destination setting unit based on the map data while avoiding the zone to be avoided obtained by the area information obtaining unit.

Further, in order to solve the aforementioned problems, the invention according to claim 6 is a route guidance method for guiding a route to a moving operator, comprising: an area information obtaining step for obtaining information on a zone to be avoided associated with map data; a location information obtaining step for obtaining location information of the operator or the route guidance device; an avoidance route setting step for setting a route to a tentative destination while avoiding entering the obtained zone to be avoided based on the obtained location information and prediction results of a moving direction of the operator or the route guidance device; and a display signal generating step for generating a display control signal for displaying the route to the set temporary destination, wherein: the avoidance route setting step includes: a moving direction prediction step for predicting a moving direction of the operator or the route guidance device based on the location information obtained by the location information obtaining step, a temporary destination setting step for setting the temporary destination along the moving direction predicted by the moving direction prediction step based on the information on the zone to be avoided obtained by the area information obtaining step and the map data, and correcting the temporary destination thereafter in the case previously defined, and a route determining step for determining a route from a location concerning the location information to the temporary destination corrected after being set by the temporary destination setting step based on the map data while avoiding the zone to be avoided obtained by the area information obtaining step.

Still further, in order to solve the aforementioned problems, the invention according to claim 8 is a route guidance processing program for causing a calculating unit provided in the route guidance device to execute: an area information obtaining step for obtaining information on a zone to be avoided associated with map data; a location information obtaining step for obtaining location information of an operator or the route guidance device; an avoidance route setting step for setting a route to a temporary destination while avoiding entering the obtained zone to be avoided based on the obtained location information and prediction results of a moving direction of the operator or the route guidance device; and a display signal generating step for generating a display control signal for displaying the route to the set temporary destination, wherein: the avoidance route setting step includes: a moving direction prediction step for predicting a moving direction of the operator or the route guidance device based on the location information obtained by the location information obtaining step, a temporary destination setting step for setting the temporary destination along the moving direction predicted by the moving direction prediction step based on the information on the zone to be avoided obtained by the area information obtaining step and the map data and correcting the temporary destination thereafter in the case previously defined, and a route determining step for determining a route from a location concerning the location information to the temporary destination corrected after being set by the temporary destination setting step based on the map data while avoiding the zone to be avoided obtained by the area information obtaining step.

### BRIEF DESCRIPTION OF THE DRAWINGS

FIG. 1 is a schematic configuration view showing a schematic configuration of a route guidance system including a personal digital assistant device according to one embodiment of the present invention;

FIG. 2 is a view showing one example of a dangerous zone peculiar to a user, and its judgment conditions;

FIG. 3 is an external view showing an entire structure of the personal digital assistant device according to one embodiment of the present invention;

FIG. 4 is a functional block diagram showing a functional configuration of the personal digital assistant device according to one embodiment of the present invention;

FIG. 5 is a flow chart showing a step of route guidance control executed by a control unit shown in FIG. 4;

FIG. 6 is a flow chart showing a detailed step at Step S100 shown in FIG. 5;

FIG. 7 is a flow chart showing a detailed step at Step S200 shown in FIG. 5;

FIG. 8 is a view for describing one example of route guidance by the personal digital assistant device when there is a route setting;

FIG. 9 is a view for describing one example of the route guidance by the personal digital assistant device when there is no route setting but is a past passage history;

FIG. 10 is a view for describing one example of the route guidance by the personal digital assistant device when there is neither the route setting nor the past passage history;

FIG. 11 is a view for describing one example of the route guidance by the personal digital assistant device in a modified example when an end point of the dangerous zone and a temporary destination are not matched with each other;

FIG. 12 is a view for describing one example of the route guidance by the personal digital assistant device in a modified example when a road ahead is a dead end;

FIG. 13 is a view for describing one example of the route guidance by the personal digital assistant device in a modified example when the temporary destination cannot be set beyond a moving direction; and

FIG. 14 is a view for describing a definition of the moving direction in the modified example when the temporary destination cannot be set beyond the moving direction.

### DETAILED DESCRIPTION OF THE PREFERRED EMBODIMENTS

Hereinafter, one embodiment of the present invention will be described referring to the drawings.

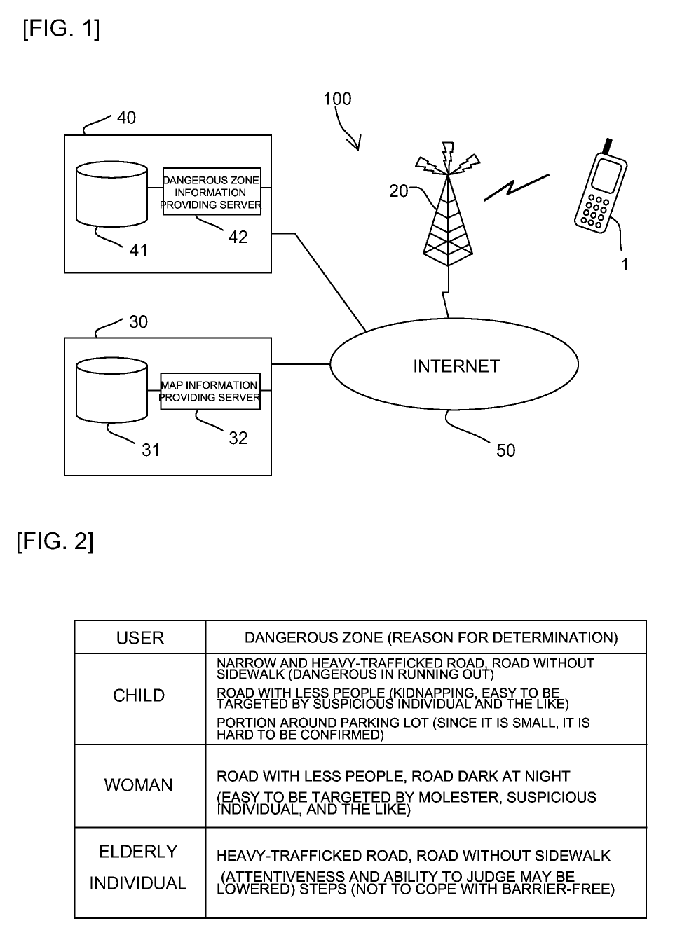

FIG. 1 is a schematic configuration view showing a schematic configuration of a route guidance system 100 including a personal digital assistant device 1 (route guidance device) according to the present embodiment. In this FIG. 1, the route guidance system 100 has the personal digital assistant device 1, a communicative base station 20 for connecting this personal digital assistant device 1 to the Internet 50, a map information providing site 30 for providing map information, the site being connected to this base station 20 through the Internet 50, a dangerous zone information providing site 40 for providing dangerous zone information, the site being similarly connected to the aforementioned base station 20 through the Internet 50. Incidentally, the aforementioned map information providing site 30 and the aforementioned dangerous zone information providing site 40 may be the same site.

The aforementioned map information providing site 30 has a map information database 31 for storing the map information, and a map information providing server 32 for providing the map information of this map information database 31. Map data of various regions are stored in the aforementioned map information database 31. A user of the personal digital assistant device 1 uses the personal digital assistant device 1 to access the map information providing site 30, and can download, by specifying desired map information, the map information to the personal digital assistant device 1 (specifically, after-mentioned map data memory 14 or working memory 17).

Meanwhile, the aforementioned dangerous zone information providing site 40 has a dangerous zone information database 41 for storing the dangerous zone information, and a dangerous zone information providing server 42 for providing the dangerous zone information of this dangerous zone information database 41. Map data of specific areas (dangerous zones) to be avoided, for example, roads closed due to construction, intersections where traffic accidents occur frequently due to heavy traffic, and the like, is previously stored in the aforementioned dangerous zone information database 41. The user of the personal digital assistant device 1 uses the personal digital assistant device 1 to access the dangerous zone information providing site 40 in a manner similar to that of the aforementioned map information providing site 30, and can download, by specifying a desired region, the dangerous zone information of the region to the personal digital assistant device 1 (specifically, the after-mentioned map data memory 14 or working memory 17).

Incidentally, dangerous zones and the like, for example, roads with few people, roads which are dark at night, and the like from a viewpoint of crime prevention, such as suspicious individuals, molesters, kidnapping, and the like are stored in the aforementioned dangerous zone information database 41 other than the dangerous zone such as the aforementioned closed roads, points of frequent traffic accidents, and the like, from the viewpoint of the traffic accident prevention. It is to be noted that the dangerous zone information may be individually registered into the personal digital assistant device 1 from the user side of the personal digital assistant device 1, for example, guardians previously select and register roads that they do not want children to pass through based on dangerous zone information obtained uniquely, and the like. The aforementioned dangerous zone information may be reflected also in the dangerous zone information database 41. Further, since judgment conditions of whether or not it is a dangerous zone may be different depending on whether the user is a child, a woman, or an elderly individual, the user's age and sex are previously registered into the personal digital assistant device 1, and only the dangerous zone information peculiar to the user may be extracted and read from the dangerous zone information of the aforementioned dangerous zone information database 41 according to this registered information. One example of the dangerous zone peculiar to the user and its judgment conditions is shown in FIG. 2.

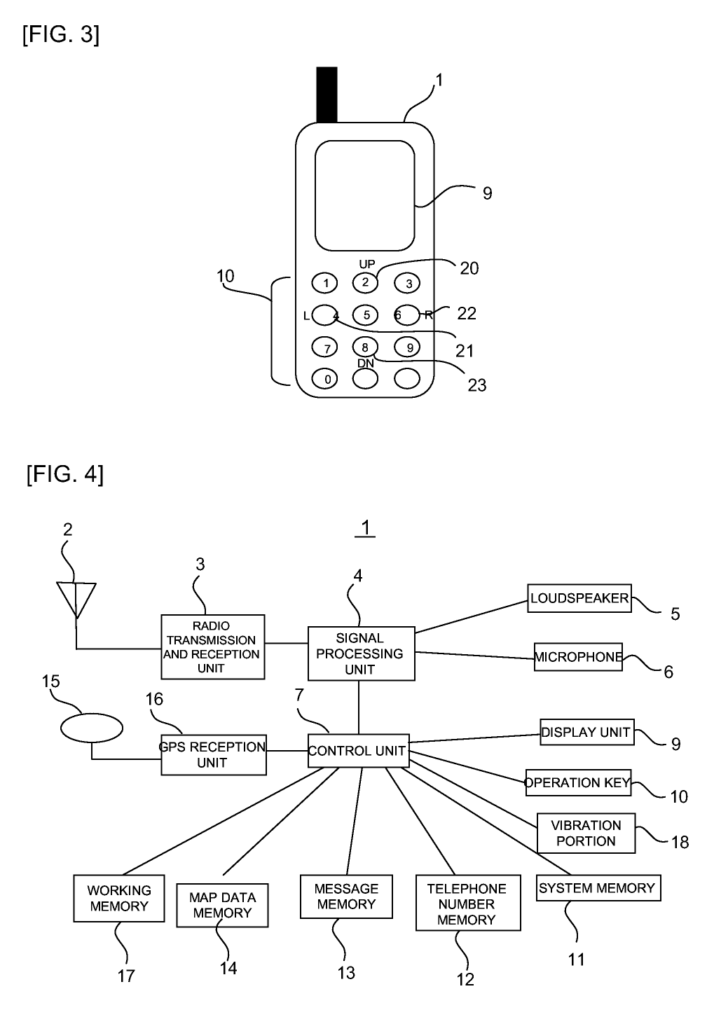

FIG. 3 is an external view showing an entire structure of the personal digital assistant device 1. As shown in FIG. 3, the personal digital assistant device 1 is a cellular phone type terminal having a telephone function, and it has a display unit 9, and a plurality of operation keys 10 composed of scroll keys 20 to 23 for scrolling display information in the display unit 9 in up, down, right, and left directions, and the like, on a front panel thereof.

FIG. 4 is a functional block diagram showing a functional configuration of the aforementioned personal digital assistant device 1. As shown in FIG. 4, the personal digital assistant device 1 is adapted to operate such that each component is controlled by a control unit 7 including CPU and the like.

Voice signals of a phone call are processed by an antenna 2, a radio transmission and reception unit 3, and a signal processing unit 4. Namely, transmitted radio waves from other telephone apparatuses are received by the antenna 2, demodulated by the radio transmission and reception unit 3, and thus the reception signals are generated. This reception signal is subjected to signal processing for reproduction by the signal processing unit 4, and is reproduced as a voice from a loudspeaker 5. Meanwhile, the user's voice is inputted into the microphone 6 and converted into voice signals. This voice signal is subjected to signal processing for transmission in the signal processing unit 4, and is sent to the radio transmission and reception unit 3. The radio transmission and reception unit 3 modulates the voice signal from the signal processing unit 4 to supply it to the antenna 2, and the antenna 2 transmits the voice signal as electric waves.

A notice to the user, such as telephone reception and the like, is performed by outputting a control signal to the signal processing unit 4 to then reproduce it as a voice from the loudspeaker 5, or outputting a control signal to the vibration portion 18 simultaneously with a voice or instead of the voice to thereby vibrate the personal digital assistant device 1.

A GPS antenna 15 receives electric waves from a plurality of satellites, and supplies received signals to a GPS receiving unit 16. The GPS receiving unit 16 calculates a current position of the personal digital assistant device 1 by utilizing a plurality of electric waves, and supplies it to the control unit 7 as current position data. The current position data may be used as data of latitude and longitude, for example, and the map data memory 14 or the working memory 17 can store it as required.

A system memory 11, a telephone number memory 12, a message memory 13, the map data memory 14, and the working memory 17 are connected to the aforementioned control unit 7. A program for executing various functions that the personal digital assistant device 1 has is previously stored in the system memory 11. The telephone number memory 12 records a plurality of telephone numbers in association with names of persons having the numbers. The message memory 13 records messages transmitted and received using the mail function and the like of the personal digital assistant device 1. Additionally, the working memory 17 is used for temporarily storing data in various processings.

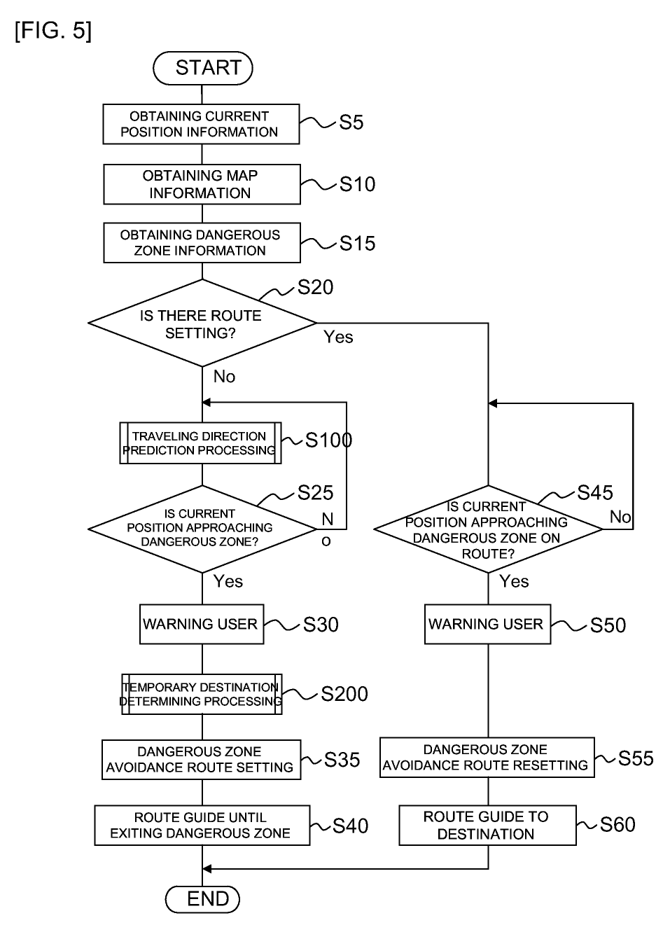

FIG. 5 is a flow chart showing a step of the route guidance control executed by the aforementioned control unit 7. This flow chart is started when the operation keys 10 are operated by the user and an instruction of the route guidance start is inputted, for example.

First, at Step S5, in response to a location information obtaining instruction inputted by the user operating the operation keys 10, location information (current location information) of the personal digital assistant device 1 calculated by the GPS receiving unit 16 by utilizing electric waves received from a plurality of satellites through the GPS antenna 15 is obtained. This location information is obtained, for example, as latitude/longitude information. It is to be noted that, thereafter, the location information is obtained every predetermined time interval (for example, every several seconds), and is stored in a suitable memory (the map data memory 14 or the working memory 17) as a passage history.

At next Step S10, in response to a map information obtaining instruction inputted by the user operating the operation keys 10, while accessing the map information providing site 30 through the base station 20 and the Internet 50, the user downloads and obtains desired map information (map information of an area around the current position based on the location information obtained at aforementioned Step S5) from the map information database 31. Incidentally, the desired map information may be previously stored in a suitable memory (the map data memory 14 and the like) of the personal digital assistant device 1, and it may be read from the memory.

At next Step S15, in response to a dangerous zone information obtaining instruction inputted by the user operating the operation keys 10, while accessing the dangerous zone information providing site 40 through the base station 20 and the Internet 50, the user downloads and obtains desired dangerous zone information (dangerous zone information of an area around the current position based on the location information obtained by aforementioned Step S5) from the dangerous zone information database 41. Incidentally, the desired dangerous zone information may be previously stored in a suitable memory (the map data memory 14 and the like) of the personal digital assistant device 1, and it may be read from the memory.

At next Step S20, a destination and a route search instruction are inputted by the user operating the operation keys 10, and it is determined whether or not a route from a current position to the destination is set. If the route is not set, the determination is not satisfied, and the step will move to next Step S100.

At Step S100, moving direction prediction processing for predicting the user's moving direction based on the passage history (a set of the latitude/longitude information) stored in a suitable memory (the map data memory 14, the working memory 17, and the like) is performed.

At next Step S25, it is determined whether or not the user has approached the dangerous zone. This determination is made based on the obtained location information (current location information), and the moving direction determined by aforementioned Step S100. Namely, it is determined whether or not the dangerous zone exists, for example, on a moving direction and within several tens of meters in radius, from the current position, and if it exists, it is determined that the user has approached the dangerous zone. Aforementioned Step S100 and present Step S25 are repeated until the user has approached the dangerous zone, and if the user has approached the dangerous zone, the determination is satisfied, and the step will move to next Step S30.

It is to be noted that here, the information on the dangerous zone itself is stored in the dangerous zone information database 41, and the approach determination is made on the personal digital assistant device 1 side that has obtained the information in consideration of a buffer zone (zone determined that the user has approached the dangerous zone) around several tens of meters of the dangerous zone as described above, but without being limited to this, an area including the buffer zone may be stored in the dangerous zone information database 41 as the dangerous zone information, for example, and the approach determination may be made by determining whether or not the user has entered the dangerous zone, on the personal digital assistant device 1 side.

At next Step S30, a control signal is outputted to the display unit 9 to display on the display unit 9 an alarm display for warning the user of having approached the dangerous zone, and the control signal is also outputted to the signal processing unit 4 to reproduce a beep sound from the loudspeaker 5. Incidentally, the control signal may be outputted to the vibration portion 18 to vibrate the personal digital assistant device 1, instead of the beep sound or simultaneous with the beep sound.

At next Step S200, temporary destination determining processing for determining a temporary destination which is a point beyond the dangerous zone is performed based on the moving direction predicted at aforementioned Step S100 (or passage history stored in a suitable memory), and the dangerous zone information.

At next Step S35, an avoidance route for avoiding the dangerous zone from the current position to the temporary destination determined by aforementioned Step S200 is set.

At next Step S40, a control signal is outputted to the display unit 9 to thereby display on the display unit 9 the dangerous zone avoidance route that is set at aforementioned Step S35, and a route guide is performed until the user exits from the dangerous zone. At this time, the control signal is outputted to the signal processing unit 4, and guidance with voice may be performed from the loudspeaker 5 together with the display by the aforementioned display unit 9. The present flow is completed as above.

It is to be noted that if the route from the current position to the destination is set at previous Step S20, the determination is satisfied, and the step will move to next Step S45.

At Step S45, if the dangerous zone exists on the set route, it is determined whether or not the user has approached the dangerous zone, namely, whether or not the obtained location information (current location information) has approached the dangerous zone information obtained at aforementioned Step S15. The present step is repeated until the user has approached the dangerous zone, and if the user has approached the dangerous zone, the determination is satisfied, and the step will move to next Step S50.

At Step S50, in a manner similar to that at aforementioned Step S30, a control signal is outputted to the display unit 9 to display on the display unit 9 an alarm display for warning the user of having approached the dangerous zone, and the control signal is also outputted to the signal processing unit 4 to reproduce a beep sound from the loudspeaker 5. Incidentally, the control signal may be outputted to the vibration portion 18 to vibrate the personal digital assistant device 1, instead of the beep sound or simultaneous with the beep sound.

At next Step S55, an avoidance route for avoiding the dangerous zone existing on the set route is determined, and the route to the destination is reset. It is to be noted that although the avoidance route may be previously set, the dangerous zone may be changed with a time zone and the like, and thus the reset shall be performed.

At next Step S60, in a manner similar to that at aforementioned Step S40, the control signal is outputted to the display unit 9, the route, which is reset at aforementioned Step S55, for reaching the destination while avoiding the dangerous zone is displayed on the display unit 9, and the route guide is performed. At this time, the control signal is outputted to the signal processing unit 4, and guidance with voice may be performed from the loudspeaker 5 together with the display by the aforementioned display unit 9. The present flow is completed as above.

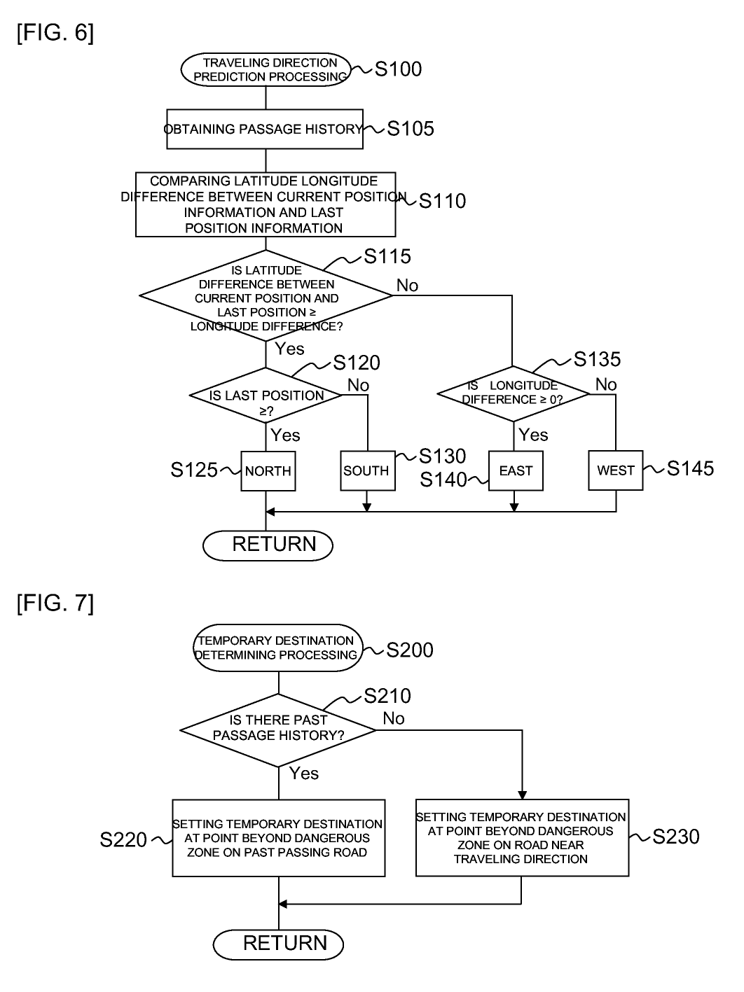

FIG. 6 is a flow chart showing a detailed step of aforementioned Step S100. First, at Step S105, last position information (for example, position information before several minutes or several hundreds meters, and the like) in the passage history (latitude/longitude information) stored in the aforementioned suitable memory (the map data memory 14, the working memory 17, and the like) is read.

At next Step S110, the current (a first period) location information (a first location information), and the aforementioned read past (a second period, for example, just before) location information (a second location information) are compared with each other to calculate a latitude difference and a longitude difference therebetween (comparing means). Here, the latitude shall represent the north latitude and the longitude shall represent the east longitude.

At next Step S115, it is determined whether or not the aforementioned calculated latitude difference is equal to the longitude difference or more. Namely, the user's moving direction is determined whether a north-south direction is dominant or an east-west direction is dominant. If the latitude difference is equal to the longitude difference or more, it is considered that the north-south direction is dominant, and the step will move to next Step S120.

At Step S120, it is determined whether or not the latitude difference is zero or more. Namely, the user's moving direction is determined whether a northward direction is dominant or a southward direction is dominant. If the latitude difference is zero or more, the determination is satisfied, and the step will move to next Step S125 to set the moving direction to “north.” Meanwhile, if the latitude difference is less than zero, the determination is not satisfied, and the step will move to next Step S130 to set the moving direction to “south.” The present routine is completed as above.

Incidentally, at aforementioned Step S115, if the latitude difference is less than the longitude difference, it is considered that the east-west direction is dominant, and the step will move to next Step S135. At Step S135, it is then determined whether the longitude difference is zero or more. Namely, the user's moving direction is determined whether an eastward direction is dominant or a westward direction is dominant. If the longitude difference is zero or more, the determination is satisfied, and the step will move to next Step S140 to set the moving direction to “east.” Meanwhile, if the longitude difference is less than zero, the determination is not satisfied, and the step will move to next Step S145 to set the moving direction to “west.” The present routine is completed as above.

Incidentally, aforementioned Step S125, Step S130, Step S140, and Step S145 configure dominant direction determining means unit in which, depending on the comparison result by the comparing means unit, if the latitude difference concerning the first location information and the second location information is larger than the longitude difference, it determines the dominant moving direction the northward direction or the southward direction, whereas if the longitude difference concerning the first location information and the second location information is larger than the latitude difference, it determines the dominant moving direction as the eastward direction or the westward direction. In addition, although the moving direction is classified into four directions of north, south, east, and west here, the direction may be classified still more finely, such as a northeast, south-southwest, and the like.

FIG. 7 is a flow chart showing a detailed step of aforementioned Step S200. First, at Step S210, it is determined whether or not there is a passage history at present that matches with the location information obtained at Step S5 (information in which the current position exists on the passage history) among the past road usage histories (for example, histories of passing through the same route yesterday or several days ago) stored in a suitable memory (the map data memory 14 and the like) of the personal digital assistant device 1 (determination means). For example, if a child performs the route guidance every day by the personal digital assistant device 1 during going to school, there is a corresponding past passage history, and thus the determination is satisfied, and the step will move to next Step S220.

At Step S220, the aforementioned past passage history is read from the memory, and a temporary destination is set to a point beyond the dangerous zone on the past passing route based on this passage history information and the dangerous zone information obtained at previous Step S15 (history destination determining means. Refer to after-mentioned FIG. 9). This routine is completed as above.

Meanwhile, at aforementioned Step S210, for example, if it is the first road to pass, there is no past passage history, and thus the determination is not satisfied, and the step will move to next Step S230.

At Step S230, based on the moving direction determined at aforementioned Step S100, and the dangerous zone information obtained at previous Step S15, the temporary destination is set to a point beyond the dangerous zone on a road near the moving direction (vicinity destination determining means. Refer to after-mentioned FIG. 10). This routine is completed as above.

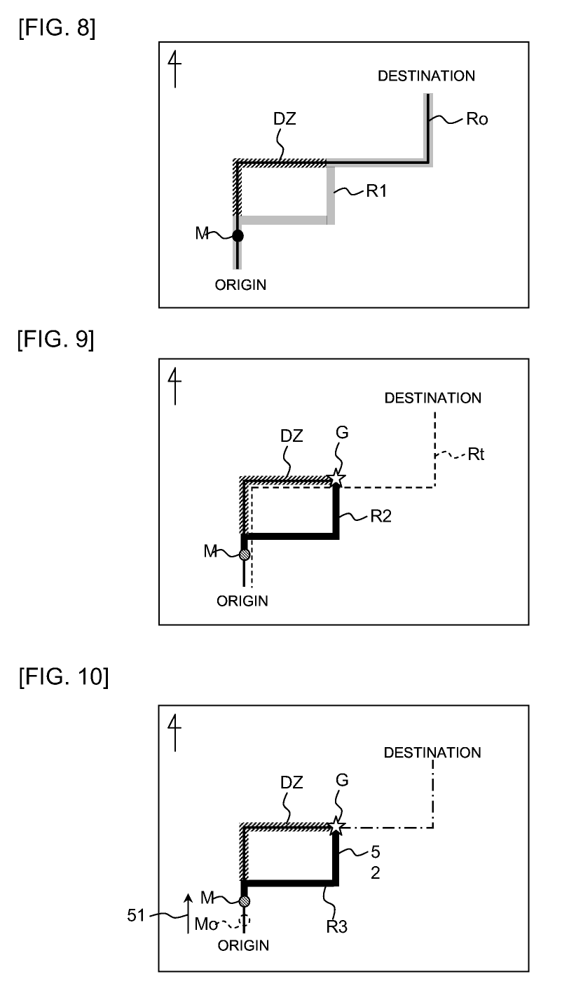

FIG. 8 is a view for describing one example of the route guidance by the personal digital assistant device 1 when there is the route setting (if the determination at Step S20 shown in FIG. 5 is satisfied). Note that, hereinafter (in FIG. 8 through FIG. 10), a case where, for example, a user M who is a child goes for its own house of the destination from a cram school of the origin will be described as an example.

In this FIG. 8, the user M has previously executed the route guidance from the cram school to its house before leaving the cram school, and a route Ro is a route set at this time. Here, there exists on this route Ro a dangerous zone DZ, for example, a road with witness information on a suspicious individual and the like. When the user M then approaches the dangerous zone DZ as shown in the figure, the determination at Step S45 in FIG. 5 is satisfied, so that a warning is made by next Step S50, and resetting of a route R1 including an avoidance route (a thick line portion in the figure) for avoiding the dangerous zone DZ is made by Step S55. As a result of this, guidance is performed to the user M by Step S60 in FIG. 5 so as to pass through the route R1.

FIG. 9 is a view for describing one example of the route guidance by the personal digital assistant device 1 in a case where there is no route setting (the case where the determination at Step S20 in FIG. 5 is not satisfied), but there is the past passage history (the case where the determination at Step S210 in FIG. 7 is satisfied).

In this FIG. 9, the user M is traveling in a direction approaching the dangerous zone DZ on the road. Since the user M does not execute the route guidance from the cram school of the origin to its house of the destination previously and the route setting is not made here, the determination at Step S20 in FIG. 5 is not satisfied. When the user M then approaches the dangerous zone DZ, the determination at Step S25 in FIG. 5 is satisfied, so that a warning is made by next Step S30, and the temporary destination determining processing is made by Step S200. At this time, a past passage history Rt (for example, a passage history when the kid passed last time) is stored in the personal digital assistant device 1. Incidentally, since there was no witness information on the suspicious individual at the last time and the dangerous zone DZ did not exist, the passage history Rt is set to a route passing through the current dangerous zone DZ. As a result, the determination at Step S210 in FIG. 7 is satisfied, so that a temporary destination G is set at a point beyond the dangerous zone DZ on the past passage history Rt by next Step S220, and an avoidance route R2 reaching the temporary destination G from the current position while avoiding the dangerous zone DZ is set by Step S35 in FIG. 5. As a result, guidance is performed to the user M by Step S40 in FIG. 5 so as to avoid the dangerous zone DZ by passing through the route R2.

FIG. 10 is a view for describing one example of the route guidance by the personal digital assistant device 1 in a case where there is no route setting (the case where the determination at Step S20 in FIG. 5 is not satisfied), and there is no past passage history (the case where the determination at Step S210 in FIG. 7 is not satisfied).

In this FIG. 10, the user M is traveling in a direction approaching the dangerous zone DZ toward the north on the road. Since the user M does not execute the route guidance from the cram school of the origin to its house of the destination previously and the route setting is not made here, the determination at Step S20 in FIG. 5 is not satisfied, so that prediction processing of the moving direction is performed by next Step S100. The current position (point of M in the figure) of the user M is compared with the last position (point of Mo in the figure) by this moving direction prediction processing, so that the moving direction is determined as, “north” (refer to an arrow 51 in the figure). When the user M then approaches the dangerous zone DZ, the determination at Step S25 in FIG. 5 is satisfied, so that the warning is made by next Step S30, and the temporary destination determining processing is made by Step S200. Namely, since there is no past passage history here, the determination at Step S210 in FIG. 7 is not satisfied, so that a road 52 is selected as a road that extends in a direction near the aforementioned determined moving direction (here, “north”) of the user M by next Step S230, and the temporary destination G is set at a point beyond the dangerous zone DZ on this road 52. An avoidance route R3 reaching the temporary destination G from the current position while avoiding the dangerous zone DZ is then set by Step S35 in FIG. 5. As a result, guidance is performed to the user M by Step S40 in FIG. 5 so as to avoid the dangerous zone DZ by passing through the route R3.

As described above, the route guidance device (in this example, the personal digital assistant device) 1 in the present embodiment is the route guidance device 1 for guiding the route of the moving operator (in this example, the user) M, and it is characterized by having area information obtaining means unit (in this example, Step S15 executed by the control unit 7) for obtaining information on a zone to be avoided (in this example, dangerous zone information) associated with map data, location information obtaining means unit (in this example, Step S5 executed by the control unit 7) for obtaining the location information of the operator M or the route guidance device 1, based on the location information obtained by the location information obtaining means step S5, and prediction results of the moving direction of the operator M or the route guidance device 1, avoidance route setting means unit (in this example, Step S100, Step S200, and Step S35 executed by the control unit 7) for setting the route to the temporary destination G while avoiding entering the zone to be avoided (in this example, dangerous zone) DZ obtained by the area information obtaining means step S15, and display signal generating means unit (in this example, Step S40 executed by the control unit 7) for generating a display control signal for displaying the route to the temporary destination G set by the avoidance route setting means step S100, S200, and S35.

In the present embodiment, when the operator M travels with the route guidance device 1, the location information is obtained by the location information obtaining means step S5. Meanwhile, the information on the zone to be avoided in the traveling action is obtained by the area information obtaining means step S15 in a form associated with the map data. The route to the temporary destination G is then set by the avoidance route setting means step S100, S200, and S35, while avoiding entering a zone to be avoided DZ, and the display control signal of the route to the temporary destination G is generated by the display signal generating means step S40, thereby allowing the route to be displayed on the display means unit (in this example, display unit) 9. At this time, the avoidance route setting means step S100, S200, and S35 sets the route to the temporary destination G based on the aforementioned location information, and the prediction results of the moving direction of the operator M (or the route guidance device 1). As a result, even when an avoidance scheduled route for avoiding the zone to be avoided DZ has not been decided in advance, the route from the current position to the temporary destination G can be reliably set so as to avoid the zone to be avoided DZ, while reflecting the prediction results of the moving direction. Hence, even when a wrong road is taken by mistake from the route usually used, for example (it is highly possible that the corresponding avoidance scheduled route has not been decided in such an accidental situation), safe and reliable route guidance can be executed from the position while avoiding the zone to be avoided DZ (it is effective to especially children, elderly individuals, and the like). Additionally, it is especially effective also to a case where the zone to be avoided DZ changes every day or every moment (since it is hard to previously set the avoidance scheduled route). Further, since it becomes unnecessary to previously set the avoidance scheduled route, it is effective in the ability to reduce an operational burden of the operator M.

The route guidance method by the route guidance device 1 in the present embodiment is a route guidance method for guiding a route of moving operator M, and it is characterized by having an area information obtaining step (in this example, Step S15 executed by the control unit 7) for obtaining information on a zone to be avoided associated with map data, a location information obtaining step (in this example, Step S5 executed by the control unit 7) for obtaining location information of the operator M or the route guidance device 1, based on the thereby obtained location information, and the prediction results of the moving direction of the operator M or the route guidance device 1, an avoidance route setting step (in this example, Step S100, Step S200, and Step S35 executed by the control unit 7) for setting a route to the temporary destination G while avoiding entering the obtained zone to be avoided DZ, and a display signal generating step (in this example, Step S40 executed by the control unit 7) for generating a display control signal for displaying the route to the set temporary destination G.

In the present embodiment, when the operator M travels, the location information is obtained by the location information obtaining step S5. Meanwhile, the information on the zone to be avoided in the traveling action is obtained by the area information obtaining step S15 in a form associated with the map data. The route to the temporary destination G is then set by the avoidance route setting step S100, S200, and S35, while avoiding entering the zone to be avoided DZ, and the display control signal of the route to the temporary destination G is generated by the display signal generating step S40, thereby allowing the route to be displayed on the display means unit 9. At this time, the avoidance route setting step S100, S200, and S35 sets the route to the temporary destination G based on the aforementioned location information and the prediction results of the moving direction of the operator M (or the route guidance device 1). As a result, even when an avoidance scheduled route for avoiding the zone to be avoided DZ has not been decided in advance, the route from the current position to the temporary destination G can be reliably set so as to avoid the zone to be avoided DZ, while reflecting the prediction results of the moving direction. Hence, even when a wrong road is taken by mistake from the route usually used, for example (it is highly possible that the corresponding avoidance scheduled route has not been decided in such an accidental situation), safe and reliable route guidance can be executed from the position while avoiding the zone to be avoided DZ (it is effective to especially children, elderly individuals, and the like). Additionally, it is especially effective also to a case where the zone to be avoided DZ changes every day or every moment (since it is hard to previously set the avoidance scheduled route). Further, since it becomes unnecessary to previously set the avoidance scheduled route, it is effective in the ability to reduce an operational burden of the operator M.

In a route guidance processing program of the route guidance device 1 in the aforementioned embodiment, it is characterized by causing calculating means unit (in this example, CPU provided in the control unit 7) provided in the route guidance device 1 to execute an area information obtaining step S15 for obtaining information on a zone to be avoided associated with map data, a location information obtaining step S5 for obtaining location information of the operator M or the route guidance device 1, an avoidance route setting step S100, S200, and S35 for setting a route to a temporary destination G while avoiding entering the obtained zone to be avoided DZ, based on the thereby obtained location information, and the prediction results of the moving direction of the operator M or the route guidance device 1, and a display signal generating step S40 for generating a display control signal for displaying the route to the set temporary destination G.

In a case of causing the route guidance device 1 to execute the route guidance processing program according to the present embodiment, when the operator M travels, the location information is obtained by the location information obtaining step S5 executed by the calculating means unit 7. Meanwhile, the information on the zone to be avoided in the traveling action is obtained by the calculating means unit 7 at the area information obtaining step S15 in a form associated with the map data. The route to the temporary destination G is then set by the calculating means unit 7 at the avoidance route setting step S100, S200, and S35, while avoiding entering the zone to be avoided DZ, and the display control signal of the route to the temporary destination G is generated by the calculating means unit 7 at the display signal generating step S40, thereby the route can be displayed on the display means unit 9. At this time, the avoidance route setting step S100, S200, and S35 sets the route to the temporary destination G based on the aforementioned location information and the prediction results of the moving direction of the operator M (or the route guidance device 1). As a result, even when an avoidance scheduled route for avoiding the zone to be avoided DZ has not been decided in advance, the route from the current position to the temporary destination G can be reliably set so as to avoid the zone to be avoided DZ, while reflecting the prediction results of the moving direction. Hence, even when a wrong road is taken by mistake from the route usually used, for example (it is highly possible that the corresponding avoidance scheduled route has not been decided in such an accidental situation), safe and reliable route guidance can be executed from that position while avoiding the zone to be avoided DZ (it is effective to especially children, elderly individuals, and the like). Additionally, it is especially effective also to a case where the zone to be avoided DZ changes every day or every moment (since it is hard to previously set the avoidance scheduled route). Further, since it becomes unnecessary to previously set the avoidance scheduled route, it is effective in the ability to reduce an operational burden of the operator M.

In the route guidance device 1 according to the aforementioned embodiment, the avoidance route setting means unit is characterized by being provided with moving direction predicting means unit (in this example, Step S100 executed by the control unit 7) for predicting the moving direction of the operator M or the route guidance device 1 based on the location information obtained by the location information obtaining means step S5, temporary destination setting means unit (in this example, Step S200 executed by the control unit 7) for setting the temporary destination G along the moving direction predicted by the moving direction predicting means step S100 based on the information on the zone to be avoided obtained by the area information obtaining means step S15, and the map data, and route determining means unit (in this example, Step S35 executed by the control unit 7) for determining a route from the location concerning the location information to the temporary destination G set by the temporary destination setting means step S200 based on the map data, while avoiding the zone to be avoided DZ obtained by the area information obtaining means step S15.

Even when the avoidance route is not set previously, the moving direction is predicted by the moving direction predicting means step S100 based on the location information, the temporary destination G along the predicted moving direction is set by the temporary destination setting means step S200, and the route to the temporary destination G is determined by the route determining means step S35, thereby allowing the route guidance to be reliably executed.

In the route guidance device 1 according to the aforementioned embodiment, the moving direction predicting means step S100 is characterized by being provided comparing means unit (in this example, Step S110 executed by the control unit 7) for comparing latitude/longitude information included in the first location information obtained by the location information obtaining means step S5 in the first period, with latitude/longitude information included in the second location information obtained by the location information obtaining means step S5 in the second period prior to this first period, and dominant direction determining means unit (in this example, Step S125, S130, S140, and, S145 executed by the control unit 7) in which, depending on the comparison result by the comparing means step S110, if the latitude difference concerning the first location information and the second location information is larger than the longitude difference, it determines the dominant moving direction as the northward direction or the southward direction, whereas if the longitude difference concerning the first location information and the second location information is larger than the latitude difference, it determines the dominant moving direction as the eastward direction or the westward direction.

The comparing means unit compares the latitude/longitude information in the past second period with the longitude latitude information in the first period after the time elapsed therefrom, so that the dominant direction determining means step S125, S130, S140, and S145 can determine that if the latitude difference (north latitude south latitude) is larger than the longitude difference (east longitude west longitude), a latitude direction of the northward direction or the southward direction is a dominant direction, whereas if the longitude difference (east longitude west longitude) is larger than the latitude difference (north latitude south latitude), a longitude direction of the eastward direction or the westward direction is the dominant direction, thereby allowing the prediction of the moving direction to be executed.

In the route guidance device 1 according to the aforementioned embodiment, the temporary destination setting means step S200 is characterized by being provided with the determination means unit (in this example, Step S210 executed by the control unit 7) for determining whether or not there is any passage history corresponding to the location information currently obtained by the location information obtaining means step S5 among passage histories Rt composed of a set of the location information obtained by the location information obtaining means step S5 in the past predetermined period, and when the determination of the determination means step S210 is satisfied, history destination determining means unit (in this example, Step S220 executed by the control unit 7) for determining the temporary destination G at a point that is located outside the zone to be avoided DZ on the passage history Rt and is along the predicted moving direction.

It is determined by the determination means step S210 whether or not there is any past passage history Rt corresponding to the current location information, so that if there is the corresponding passage history Rt, the point that is located outside the zone to be avoided DZ in the passage history Rt and is along the moving direction predicted by the moving direction predicting means step S100 can be determined as the safe and reliable temporary destination G by the history destination determining means step S220, while attaching importance on the actual result of having passed it before.

In the route guidance device 1 according to the aforementioned embodiment, the temporary destination setting means step S200 is characterized by being provided with the determination means step S210 for determining whether or not there is any passage history corresponding to the location information currently obtained by the location information obtaining means step S5 among the passage histories Rt composed of a set of the location information obtained by the location information obtaining means step S5 in the past predetermined period, and if the determination of this determination means step S210 is not satisfied, the vicinity destination determining means unit (in this example, Step S230 executed by the control unit 7) for determining the temporary destination G at a point that is located on a road near the predicted moving direction and is outside the zone to be avoided DZ.

It is determined by the determination means step S210 whether or not there is any past passage history Rt corresponding to the current location information, and if there is no corresponding passage history Rt, a moving direction is predicted, and the temporary destination G is determined at the point that is located on the road near the moving direction and is outside the zone to be avoided DZ by the vicinity destination determining means step S230. As a result, even when there is no past passage history Rt, such as a case of, for example, going off the road by mistake from the route usually used, the route from the current position to the temporary destination G can be reliably set while avoiding the zone to be avoided DZ, while reflecting the prediction results of the moving direction.

In the route guidance device 1 according to the aforementioned embodiment, it is characterized in that the avoidance route setting means step S100, S200, and S35 is provided with a prediction setting mode in which the moving direction predicting means step S100 predicts the moving direction, the temporary destination setting means step S200 sets a temporary destination G along the predicted moving direction, and the route determining means step S35 determines a route to the set temporary destination G, and a scheduled setting mode for setting an avoidance scheduled route previously prepared in order to avoid entering the zone to be avoided DZ, the modes being able to be selectively switched, and if the avoidance route setting means unit (in this example, Step S55 executed by the control unit 7) is switched to the scheduled setting mode, the display signal generating means unit (in this example, Step S60 executed by the control unit 7) generates a display control signal for displaying a route including the avoidance scheduled route corresponding to the location information.

Two modes of the prediction setting mode and the scheduled setting mode are prepared previously and configured to be switchable, so that even when the avoidance scheduled route is set previously, such as a case where, for example, there is a route setting, it can deal with it, and thus allowing convenience of the operator M to be improved.

A route guidance method by the route guidance device 1 in the present embodiment is characterized in that the avoidance route setting step S100, S200, and S35 is a step that can selectively switch a prediction setting mode for executing a moving direction prediction step S100 for predicting the moving direction of the operator or the route guidance device 1 based on the location information obtained by the location information obtaining step S5, a temporary destination setting step S200 for setting a temporary destination along the moving direction predicted by the moving direction prediction step S100 based on the information on the zone to be avoided obtained by the area information obtaining step S15, and the map data, and a route determining step S35 for determining a route from a position concerning the location information to the temporary destination set by the temporary destination setting step S200 based on the map data while avoiding the zone to be avoided DZ obtained by the area information obtaining step S15, and a scheduled setting mode for setting an avoidance scheduled route previously prepared in order to avoid entering the zone to be avoided DZ, and if the avoidance route setting step S55 is switched to the scheduled setting mode, the display signal generating step S60 generates a display control signal for displaying a route including the avoidance scheduled route corresponding to the location information.

Two modes of the prediction setting mode and the scheduled setting mode are prepared previously and configured to be switchable, so that even when the avoidance scheduled route is set previously such as a case where, for example, there is a route setting, it can deal with it, and thus allowing convenience of the operator M to be improved.

In a route guidance processing program of the route guidance device 1 in the aforementioned embodiment, it is characterized in that the avoidance route setting step S100, S200, and S35 is a step that can be selectively switch a prediction setting mode for executing a moving direction prediction step S100 for predicting the moving direction of the operator or the route guidance device 1 based on the location information obtained by the location information obtaining step S5, a temporary destination setting step S200 for setting a temporary destination along the moving direction predicted by the moving direction prediction step S100 based on the information on the zone to be avoided obtained by the area information obtaining step S15, and the map data, and route determining step S35 for determining a route from a position concerning the location information to the temporary destination set by the temporary destination setting step S200 based on the map data while avoiding the zone to be avoided DZ obtained by the area information obtaining step S15, and a scheduled setting mode for setting an avoidance scheduled route previously prepared in order to avoid entering the zone to be avoided DZ, and if the avoidance route setting step S55 is switched to the scheduled setting mode, the display signal generating step S60 generates a display control signal for displaying a route including the avoidance scheduled route corresponding to the location information.

Two modes of the prediction setting mode and the scheduled setting mode are prepared previously and configured to be switchable, so that even when the avoidance scheduled route is set previously such as a case where, for example, there is a route setting, it can deal with it, and thus allowing convenience of the operator M to be improved.

It is to be noted that the present embodiment is not limited to above embodiments, but various modifications may be made. Hereinafter, such modified examples will be described in turn.

(1) A Case where the End Point of the Dangerous Zone Does not Match with the Temporary Destination

A case where the end point matches with the temporary destination G of the dangerous zone DZ was described as an example in FIG. 9 and FIG. 10 in the aforementioned embodiment, but without being limited to this, the present invention is also applicable in a case where the end point does not match with the temporary destination G of the dangerous zone DZ.

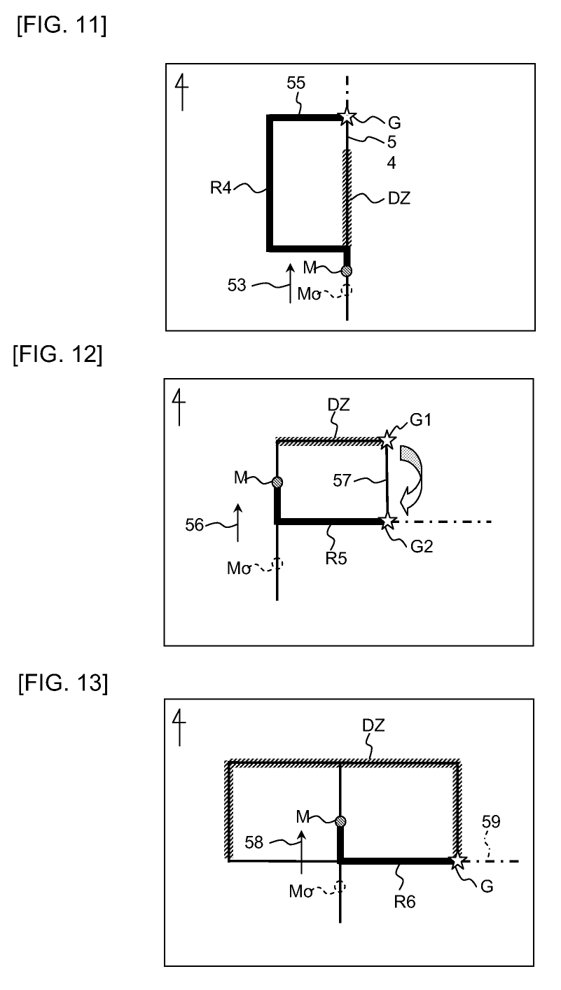

FIG. 11 is a view for describing one example of the route guidance by the personal digital assistant device 1 according to the present modified embodiment. The example shown in this figure is a case where there is no route setting (the case where the determination at Step S20 in FIG. 5 is not satisfied), and there is no past passage history (the case where the determination at Step S210 in FIG. 7 is not satisfied) similar to the aforementioned FIG. 10.

In this FIG. 11, the user M is traveling in a direction approaching the dangerous zone DZ toward the north on the road. Since the user M has not made route setting previously here, the determination at Step S20 in FIG. 5 is not satisfied, so that prediction processing of the moving direction is performed by next Step S100. The current position (point of M in the figure) of the user M is compared with the last position (point of Mo in the figure) by this moving direction prediction processing, so that the moving direction is determined as, “north” (refer to an arrow 53 in the figure). When the user M then approaches the dangerous zone DZ, the determination at Step S25 in FIG. 5 is satisfied, so that a warning is made by next Step S30, and the temporary destination determining processing is made by Step S200. Namely, a road 54 on the north side of the dangerous zone DZ is selected as a road that extends in a direction near the aforementioned determined moving direction (here “north”) of the user M by Step S230 in FIG. 7. The temporary destination G is then set at an intersection between this road 54 and another road 55 reachable from the current position. An avoidance route R4 reaching the temporary destination G from the current position while avoiding the dangerous zone DZ is then set by Step S35 in FIG. 5. As a result, guidance is performed to the user M by Step S40 in FIG. 5 so as to avoid the dangerous zone DZ by passing through the route R4.

Effects similar to those of the aforementioned embodiment can be obtained also in the present modified embodiment described above.

(2) A Case where a Road Ahead is Dead End

Although the temporary destination is set at the point that is on the road near the moving direction and beyond the dangerous zone if there is no past passage history in the aforementioned embodiment, this setting method may not be preferable in some cases, for example, a case where a point ahead of the dangerous zone is dead end, and the like. The present modified embodiment is an example to deal with a case where a point ahead of the dangerous zone is dead end as described above.

FIG. 12 is a view for describing one example of the route guidance by the personal digital assistant device 1 according to the present modified embodiment. The example shown in this figure is a case where there is no route setting (the case where the determination at Step S20 in FIG. 5 is not satisfied), and there is no past passage history (the case where the determination at Step S210 in FIG. 7 is not satisfied).

In this FIG. 12, the user M is traveling in a direction approaching the dangerous zone DZ toward the north on the road. Since the user M has not made route setting previously here, the determination at Step S20 in FIG. 5 is not satisfied, so that prediction processing of the moving direction is performed by next Step S100. The current position (point of M in the figure) of the user M is compared with the last position (point of Mo in the figure) by this moving direction prediction processing, so that the moving direction is determined as, “north” (refer to an arrow 56 in the figure). When the user M then approaches the dangerous zone DZ, the determination at Step S25 in FIG. 5 is satisfied, so that a warning is made by next Step S30, and the temporary destination determining processing is made by Step S200. Namely, a road 57 is selected as a road that extends in a direction near the aforementioned determined moving direction (here “north”) of the user M by Step S230 in FIG. 7. If a temporary destination (shown by G1 in the figure) is set at a point beyond the dangerous zone DZ on this road 57 in a manner similar to that of the aforementioned embodiment at this time, it is not preferable since a point ahead of the temporary destination G1 becomes the dangerous zone DZ. Accordingly, in the present modified embodiment, the temporary destination G1 is moved to a point G2 (hereinafter, called temporary destination G2) which can branch to a roads other than the dangerous zone DZ as shown in FIG. 12. An avoidance route R5 reaching the temporary destination G2 from the current position while avoiding the dangerous zone DZ is then set by Step S35 in FIG. 5, and guidance is performed to the user M by Step S40 in FIG. 5 so as to pass through the route R5. It is to be noted that the avoidance route R5 reaching the eventually fixed temporary destination G2 is displayed on the display unit 9 of the personal digital assistant device 1, and the process of the temporary destination movement will not be displayed.

In the route guidance device 1 in the present modified embodiment, it is characterized in that if the route determination to the temporary destination G1 set by the route determining means step S35 is difficult or impossible, the temporary destination setting means step S200 corrects and resets the set temporary destination G1, and the route determining means step S35 determines the route from the position to the reset temporary destination G2 based on the map data while avoiding the zone to be avoided DZ.

As a result, if the route determination while avoiding the zone to be avoided DZ is difficult or impossible, such as a case where the temporary destination G1 once set along the moving direction is beyond the dead-end, and the like, the temporary destination G2 can be reset to thereby redraw a route by the route determining means step S35.

(3) A Case where the Temporary Destination Cannot be Set Ahead of the Moving Direction

Although the temporary destination is set at the point that is on the road near the moving direction and beyond the dangerous zone if there is no past passage history in the aforementioned embodiment, there is a case where the temporary destination may not be set ahead of the moving direction. The present modified embodiment is an example to deal with such a case.

FIG. 13 is a view for describing one example of the route guidance by the personal digital assistant device 1 according to the present modified embodiment. The example shown in this figure is a case where there is no route setting (the case where the determination at Step S20 in FIG. 5 is not satisfied), and there is no past passage history (the case where the determination at Step S210 in FIG. 7 is not satisfied).

In this FIG. 13, while the user M is traveling in a direction approaching the dangerous zone DZ toward the north on the road, a point of the moving direction of the user M is dead end, and this whole dead-end is the dangerous zone DZ. In such a case, a temporary destination cannot be set in a manner similar to that of as the aforementioned embodiment. Accordingly, a priority is previously set to the moving direction in the present modified embodiment. For example, if the moving direction is north, a priority is given in order of north, east, west, and south. Meanwhile, if the moving direction is south, the priority is given in order of south, west, east, and north. If the temporary destination cannot be set in a certain direction, then the moving direction is switched to a direction with the next priority, and the temporary destination is set in that direction.

In the example shown in FIG. 13, the current position (point of M in the figure) of the user M is compared with the last position (point of Mo in the figure), and the moving direction is determined to “north” (refer to an arrow 58 in the figure). However, since the temporary destination cannot be set to the northward direction as described above, the moving direction is determined to “east” according to the above-described priority. The road 59 is then selected as a road that extends in a direction near this eastward direction, and the temporary destination G is set at a point beyond the dangerous zone DZ on this road 59. An avoidance route R6 reaching the temporary destination G from the current position while avoiding the dangerous zone DZ is then set by Step S35 in FIG. 5. As a result, guidance is performed to the user M by Step S40 in FIG. 5 so as to avoid the dangerous zone DZ by passing through the route R6.

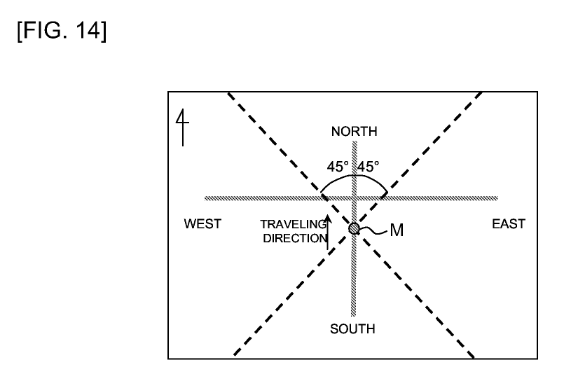

It is to be noted that as for a definition of north, south, east, and west as the above-described moving direction, a range of east and west 45 degrees due north of the current position is defined as north as shown in, for example, FIG. 14, and the definition shall be similarly applied to other directions. At this time, as for handling on the line of 45 degrees, a range of north is set as, for example, more than east 45 degrees due north and not more than west 45 degrees due north, and the handling shall be similarly applied to other directions. However, the definition of the direction is not limited to this, but the setting can be suitably changed by the user.

In the route guidance device 1 in the present modified embodiment, it is characterized in that if the setting of the temporary destination G along the moving direction predicted by the moving direction predicting means step S100, by the temporary destination setting means step S200 is difficult or impossible, it has the semi-direction setting means unit (in this example, the control unit) 7 for setting a direction pursuant to the moving direction predicted by the moving direction predicting means step S100 based on a predetermined correlation (in this example, priority), The temporary destination setting means step S200 resets the temporary destination G along the direction pursuant to the moving direction set by the semi-direction setting means unit 7, and the route determining means step S35 determines the route from the position to reset temporary destination G based on the map data while avoiding the zone to be avoided DZ.

As a result, when the setting of the temporary destination G along the moving direction itself is difficult or impossible, such as a case where the zone to be avoided DZ spreads into the wide whole area in the moving direction, and the like, the semi-direction setting means unit 7 can set the direction pursuant to the moving direction, the temporary destination setting means step S200 can set the temporary destination G along therewith, and the route determining means step S35 can redraw the route.

(4) Other Cases

The case where the present invention is applied to the personal digital assistant device for performing the route guidance for the pedestrian has been described as an example in the aforementioned embodiment, but without being limited to this, it may be applied to, for example, a navigation apparatus mounted in vehicles, such as a automobile. Additionally, the case where the route guidance is performed in the outdoors where the map information can be obtained has been described as an example in the aforementioned embodiment, but without being limited to this, the present invention may be applied to a route guidance device for performing route guidance in a limited predetermined area, such as a case of performing route guidance in, for example, exhibition venues and commercial establishment, and the like. In such a case, the location information of the user is obtained not only utilizing GPS as the aforementioned embodiment, but when the position information obtaining means unit by, for example, a magnetic sensor or wireless is provided within the area, the location information of the user may also obtained using the position information obtained by the position information obtaining means unit.

The personal digital assistant device 1 in the aforementioned embodiment is a personal digital assistant device 1 for guiding the route of the travelling user M, and it has the control unit 7 (specifically, Step S15 executed by the control unit 7) for obtaining the dangerous zone information associated with map data, the control unit 7 (specifically, Step S5 executed by the control unit 7) for obtaining the location information of the user M or the personal digital assistant device 1, the control unit 7 (specifically, Step S100, Step S200, and Step S35 executed by the control unit 7) for setting the route to the temporary destination G while avoiding entering the dangerous zone DZ obtained by the control unit 7 based on the location information obtained by this control unit 7 and the prediction results of the moving direction of the user M or the personal digital assistant device 1, and the control unit 7 (specifically, Step S40 executed by the control unit 7) for generating the display control signal for displaying a route to the temporary destination G set by this control unit 7.

In the present embodiment, if the user M travels with the personal digital assistant device 1, the location information is obtained by the control unit 7. Meanwhile, the information on the dangerous zone to be avoided in the travelling action is obtained by the control unit 7 in a form associated with the map data. The route to the temporary destination G is then set by the control unit 7 while avoiding entering the dangerous zone DZ, and the display control signal of the route to the temporary destination G is generated by the control unit 7, thereby the route can be displayed on the display unit 9. At this time, the control unit 7 sets the route to the temporary destination G based on the aforementioned location information, and the prediction results of the moving direction of the user M (or the personal digital assistant device 1). As a result, even when an avoidance scheduled route for avoiding the dangerous zone DZ has not been decided in advance, the route from the current position to the temporary destination G can be reliably set so as to avoid the dangerous zone DZ, while reflecting the prediction results of the moving direction. Hence, even when a wrong road is taken erroneously from the route usually used, for example (it is highly possible that the corresponding avoidance scheduled route has not been decided in such an accidental situation), safe and reliable route guidance can be executed from that position while avoiding the dangerous zone DZ (it is effective to especially children, elderly individuals, and the like). Additionally, it is especially effective also to a case where the dangerous zone DZ changes every day or every moment (since it is hard to previously set the avoidance scheduled route). Further, since it becomes unnecessary to previously set the avoidance scheduled route, it is effective in the ability to reduce an operational burden of the user M.

A route guidance method by the personal digital assistant device 1 according to the present embodiment is a route guidance method for guiding a route of the travelling user M, it is characterized by having a procedure at Step S15 executed by the control unit 7 that obtains dangerous zone information associated with map data, a procedure at Step S5 executed by the control unit 7 that obtains location information of the user M or the personal digital assistant device 1, a procedure at Step S100, Step S200, and Step S35 executed by the control unit 7 that sets a route to a temporary destination G while avoiding entering the obtained dangerous zone DZ based on the obtained location information and the prediction results of the moving direction of the user M or the personal digital assistant device 1, and a procedure at Step S40 executed by the control unit 7 that generates a display control signal for displaying a route to the set temporary destination G.

In the present embodiment, when the user M travels, the location information is obtained by the procedure of Strep S5 executed by the control unit 7. Meanwhile, the information on the dangerous zone to be avoided in the travelling action is obtained by the procedure at Step S15 executed by the control unit 7 in a form associated with the map data. The route to the temporary destination G is set by the procedure at Step S100, Step S200, and Step S35 executed by the control unit 7 while avoiding entering the dangerous zone DZ, and the display control signal of the route to the temporary destination G is generated by the procedure at Step S40 executed by the control unit 7, and thereby the route can be displayed on the display unit 9. At this time, in the procedure at Step S100, Step S200, and Step S35 executed by the control unit 7, the route to the temporary destination G is set based on the aforementioned location information, and the prediction results of the moving direction of the user M (or the personal digital assistant device 1). As a result, even when an avoidance scheduled route for avoiding the dangerous zone DZ has not been decided in advance, the route from the current position to the temporary destination G can be reliably set so as to avoid the dangerous zone DZ, while reflecting the prediction results of the moving direction. Hence, even when a wrong road is taken erroneously from the route usually used, for example (it is highly possible that the corresponding avoidance scheduled route has not been decided in such an accidental situation), safe and reliable route guidance can be executed from that position while avoiding the dangerous zone DZ (it is effective to especially children, elderly individuals, and the like). Additionally, it is especially effective also to a case where the dangerous zone DZ changes every day or every moment (since it is hard to previously set the avoidance scheduled route). Further, since it becomes unnecessary to previously set the avoidance scheduled route, it is effective in the ability to reduce an operational burden of the user M.

1-12. (canceled)

13. A route guidance device for guiding a route to a moving operator, comprising:
an area information obtaining unit that obtains information on a zone to be avoided associated with map data;
a location information obtaining unit that obtains location information of said operator or said route guidance device;
an avoidance route setting unit that sets a route to a temporary destination while avoiding entering the zone to be avoided obtained by said area information obtaining unit; based on said location information obtained by said location information obtaining unit and prediction results of a moving direction of said operator or said route guidance device, and
a display signal generating unit that generates a display control signal for displaying the route to said temporary destination set by said avoidance route setting unit, wherein:
said avoidance route setting unit includes:
a moving direction predicting unit that predicts the moving direction of said operator or said route guidance device based on said location information obtained by said location information obtaining unit,
a temporary destination setting unit that sets a temporary destination along the moving direction predicted by said moving direction predicting unit based on the information on the zone to be avoided obtained by said area information obtaining unit and said map data, and corrects said temporary destination thereafter in the case previously defined,
a route determining unit that determines the route from a location concerning said location information to said temporary destination corrected after being set by said temporary destination setting unit based on said map data while avoiding the zone to be avoided obtained by said area information obtaining unit.

14. The route guidance device according to claim 13, wherein:
said moving direction predicting unit includes:
a comparing unit that compares latitude/longitude information included in first location information obtained by said location information obtaining unit in a first period with latitude/longitude information included in second location information obtained by said location information obtaining unit in a second period prior to this first period,
a dominant direction determining unit that determines said dominant moving direction as said northward direction or said southward direction when said latitude difference concerning said first location information and said second location information is larger than said longitude difference and determines said dominant moving direction as said eastward direction or said westward direction when said longitude difference concerning said first location information and said second location information is larger than said latitude difference, based on a comparison result by said comparing unit.

15. The route guidance device according to claim 13, wherein:
said temporary destination setting unit corrects and resets said set temporary destination when the route determination to the temporary destination set by said route determining unit is difficult or impossible, and
said route determining unit determines a route from said location to said reset temporary destination based on said map data while avoiding said zone to be avoided.

16. The route guidance device according to claim 13, further comprising a semi-direction setting unit that sets a direction pursuant to said moving direction predicted by said moving direction predicting unit based on a predetermined correlation in case that the setting of said temporary destination along said moving direction predicted by said moving direction predicting unit, by said temporary destination setting unit is difficult or impossible, wherein:
said temporary destination setting unit resets said temporary destination along the direction pursuant to said moving direction set by said semi-direction setting unit, and
said route determining unit determines a route from said location to said reset temporary destination based on said map data while avoiding said zone to be avoided.

17. The route guidance device according to claim 13, wherein:
said avoidance route setting unit has a prediction setting mode in which said moving direction predicting unit predicts said moving direction, said temporary destination setting unit sets a temporary destination along the predicted moving direction, and said route determining unit determines a route to the set temporary destination, and a scheduled setting mode for setting an avoidance scheduled route previously prepared in order to avoid entering said zone to be avoided, the modes being able to be selectively switched, and said display signal generating unit generates a display control signal for displaying a route including said avoidance scheduled route corresponding to said location information in case that said avoidance route setting unit is switched to said scheduled setting mode.

18. A route guidance method for guiding a route to a moving operator, comprising:
an area information obtaining step for obtaining information on a zone to be avoided associated with map data;
a location information obtaining step for obtaining location information of the operator or the route guidance device;
an avoidance route setting step for setting a route to a tentative destination while avoiding entering the obtained zone to be avoided based on said obtained location information and prediction results of a moving direction of the operator or the route guidance device; and
a display signal generating step for generating a display control signal for displaying the route to said set temporary destination, wherein:
said avoidance route setting step includes:
a moving direction prediction step for predicting a moving direction of said operator or said route guidance device based on said location information obtained by said location information obtaining step,
a temporary destination setting step for setting said temporary destination along the moving direction predicted by said moving direction prediction step based on the information on the zone to be avoided obtained by said area information obtaining step and said map data, and correcting said temporary destination thereafter in the case previously defined, and
a route determining step for determining a route from a location concerning said location information to said temporary destination corrected after being set by said temporary destination setting step based on said map data while avoiding the zone to be avoided obtained by said area information obtaining step.

19. The route guidance method according to claim 18, wherein:
said avoidance route setting step is a step that can selectively switch a prediction setting mode for executing said moving direction prediction step, said temporary destination setting step, and said route determining step, and a scheduled setting mode for setting an avoidance scheduled route previously prepared in order to avoid entering said zone to be avoided, and
said display signal generating step generates a display control signal for displaying a route including said avoidance scheduled route corresponding to said location information, when said avoidance route setting step is switched to said scheduled setting mode.

20. A route guidance processing program for causing a calculating unit provided in the route guidance device to execute:
an area information obtaining step for obtaining information on a zone to be avoided associated with map data;
a location information obtaining step for obtaining location information of an operator or the route guidance device;
an avoidance route setting step for setting a route to a temporary destination while avoiding entering the obtained zone to be avoided based on said obtained location information and prediction results of a moving direction of said operator or said route guidance device; and
a display signal generating step for generating a display control signal for displaying the route to said set temporary destination, wherein:
said avoidance route setting step includes:
a moving direction prediction step for predicting a moving direction of said operator or said route guidance device based on said location information obtained by said location information obtaining step,
a temporary destination setting step for setting said temporary destination along said moving direction predicted by said moving direction prediction step based on the information on the zone to be avoided obtained by said area information obtaining step and said map data and correcting said temporary destination thereafter in the case previously defined, and
a route determining step for determining a route from a location concerning said location information to said temporary destination corrected after being set by said temporary destination setting step based on said map data while avoiding the zone to be avoided obtained by said area information obtaining step.

21. The route guidance processing program according to claim 20, wherein:
said avoidance route setting step is a step that can selectively switch a prediction setting mode for executing said moving direction prediction step, said temporary destination setting step, and said route determining step, and
a scheduled setting mode for setting an avoidance scheduled route previously prepared in order to avoid entering said zone to be avoided, and
said display signal generating step generates a display control signal for displaying a route including said avoidance scheduled route corresponding to said location information, when said avoidance route setting step is switched to said scheduled setting mode.
